(19) United States
(12) Patent Application Publication
(10) Pub. No.: US 2013/0149624 A1
(43) Pub. Date: Jun. 13, 2013

(54) AIR-INTAKE APPARATUS FOR AIR-COOLED FUEL CELL

(71) Applicants: Yohei Takada, Shizuoka-ken (JP); Kengo Ikeya, Shizuoka-ken (JP); Yoshimasa Matsumoto, Shizuoka-ken (JP); Kazuyuki Hirota, Shizuoka-ken (JP)

(72) Inventors: Yohei Takada, Shizuoka-ken (JP); Kengo Ikeya, Shizuoka-ken (JP); Yoshimasa Matsumoto, Shizuoka-ken (JP); Kazuyuki Hirota, Shizuoka-ken (JP)

(73) Assignee: Suzuki Motor Corporation, Shizuoka-ken (JP)

(21) Appl. No.: 13/805,394

(22) PCT Filed: Jul. 13, 2011
(86) PCT No.: PCT/JP2011/065924

§ 371 Date: Dec. 19, 2012

(30) Foreign Application Priority Data
Aug. 24, 2010 (JP) 2010-186753

(51) Int. Cl. H01M 8/04

(52) U.S. Cl. CPC H01M 8/04358; H01M 8/04723
USPC 429/439

(57) ABSTRACT

An air-intake apparatus for an air-cooled fuel cell according to this invention is provided with outside air temperature-detecting means; an outside air flow passage; an outside air flow rate-regulating valve; inside air temperature-detecting means; an inside air flow passage; an inside air flow rate-regulating valve; an air-conditioning air passage; an air-conditioning air flow rate-regulating valve; and air-intake control means for driving and controlling the outside air flow rate-regulating valve, the inside air flow rate-regulating valve, and the air-conditioning air flow rate-regulating valve on the basis of respective temperatures detected by the outside air temperature-detecting means and the inside air temperature-detecting means, wherein this air-intake control means generates a gas having a temperature optimized by making the gas pass through one or more of these flow passages and regulating valves, and supplies this gas to the fuel cell main unit as an oxidizing gas.

### TECHNICAL FIELD

The present invention relates to air-intake apparatuses for air-cooled fuel cells. More particularly, the invention relates to an air-intake apparatus for an air-cooled fuel cell capable of temperature-regulating an oxidizing gas supplied to the fuel cell main unit of the air-cooled fuel cell and maintaining the fuel cell main unit at a temperature capable of causing power generation.

### BACKGROUND ART

The operable temperature range of a fuel cell mounted on a vehicle is fixed, and therefore, the fuel cell needs to be cooled and heated, so that the temperature of a fuel cell main unit falls within the temperature range. A conventional commonly-used water-cooled fuel cell is configured as illustrated in FIG. 7. A water-cooled fuel cell 101 illustrated in FIG. 7 is provided with a fuel cell main unit 102 including a multitude of cells of the minimum constituent unit (unit cells) stacked therein, and a compressed hydrogen gas stored in a high-pressure hydrogen tank 103 is introduced into an anode air-intake unit 106 of the fuel cell main unit 102 through a pressure-reducing valve 105 by using an anode air-intake passage 104. On the other hand, the water-cooled fuel cell 101 compresses intake air introduced into a cathode air-intake passage 108 through a filter 107 by a compressor 109 and introduces the intake air into a cathode air-intake unit 110 of the fuel cell main unit 102 as an oxidizing gas. Consequently, in the water-cooled fuel cell 101, power generation is performed by the multitude of cells stacked in the fuel cell main unit 102.

A cathode exhaust gas discharged from the cathode exhaust unit 111 of the fuel cell main unit 102 to the cathode exhaust passage 112 is released into the outside air through a back pressure valve 114 intended for the pressure control of a cathode system, after part of the water content of the exhaust gas is separated out by a steam-water separator 113. Likewise, an anode exhaust gas discharged from an anode exhaust unit 115 of the fuel cell main unit 102 into an anode exhaust passage 116 passes through a steam-water separator 117, and is mixed into the cathode exhaust gas through a purge valve 118 by using an anode exhaust passage 116 connected to an intermediate part of the cathode exhaust passage 112. The volume of purge hydrogen discharged from the anode exhaust unit 115 is reduced in concentration to less than a lower concentration limit of combustibility by the cathode exhaust gas and is released into the outside air.

In order to improve the utilization ratio of hydrogen, the water-cooled fuel cell 101 is configured so that the anode exhaust passage 116 is connected to the anode air-intake unit 106 by using an anode return passage 119 to recirculate the anode exhaust gas to the anode air-intake unit 106 by means of a hydrogen pump 120 provided in the anode return passage 119.

The water-cooled fuel cell 101 is provided with a cooling system 121 of a water-cooling type. In a cooling water lead-in passage 122 of the cooling system 121, a water pump 123 is provided in a stage followed by the fuel cell main unit 102 to pressure-feed cooling water to a radiator 124. The cooling water with which the fuel cell main unit 102 is cooled exchanges heat with the atmosphere at the radiator 124, and is then once again returned to a stage following the fuel cell main unit 102 by a cooling water lead-out passage 125. Note that a heating apparatus 127 for an air-conditioning apparatus 126 is provided in this cooling system 121. The heating apparatus 127 is provided with a heating passage 128 for connection between the cooling water lead-in passage 122 and the cooling water lead-out passage 125, and comprises a heater core 130 for heating a vehicle interior in the heating passage 128 in parallel with the radiator 124 through a regulating valve 129. If heating is necessary, the air-conditioning apparatus 126 supplies high-temperature cooling water to the heater core 130 by opening the regulating valve 129 of the heating apparatus 127, and heats the vehicle interior by driving a fan 131 for air blowing.

As described above, the water-cooled fuel cell 101 comprises many auxiliary devices, including the compressor 109 for compressing introduced intake air, in order to increase the output density of the fuel cell main unit 102. Consequently, the water-cooled fuel cell 101 tends to be complex in system configuration, large in size, heavy in weight, and high in cost.

In contrast, an air-cooled fuel cell is available which excludes such auxiliaries as a compressor as much as possible, and adopts an air-cooling system to cool a fuel cell, thereby simplifying system configuration. As illustrated in FIG. 8, an air-cooled fuel cell 201 is provided with a fuel cell main unit 202 including a multitude of cells of the minimum constituent unit (unit cells) stacked therein. A compressed hydrogen gas stored in a high-pressure hydrogen tank 203, after being depressurized by a pressure-reducing valve 205 of an anode air-intake passage 204, is introduced into an anode air-intake unit 206 of the fuel cell main unit 202. On the other hand, unlike the water-cooled fuel cell 101 of FIG. 7, the air-cooled fuel cell 201 does not include the compressor 109. The air-cooled fuel cell 201 uses intake air introduced into a cathode air-intake passage 208 through a filter 207 as an oxidizing gas, and supplies this oxidizing gas to a cathode air-intake unit 210 of the fuel cell main unit 202 by a low-pressure gas supply fan 209.

The oxidizing gas supplied to the cathode air-intake unit 210 not only is conducive to a power generation reaction in the multitude of cells stacked within the fuel cell main unit 202 as a gas for reaction with hydrogen, but also has the role of drawing waste heat from the fuel cell main unit 202 and cooling the fuel cell main unit 202.

The oxidizing gas, after having reacted with hydrogen and cooled down the fuel cell main unit 202, is discharged from a cathode exhaust unit 211 of the fuel cell main unit 202 into a cathode exhaust passage 212 and is released into the outside air. The anode exhaust gas discharged from an anode exhaust unit 213 of the fuel cell main unit 202 into an anode exhaust passage 214 is mixed into the cathode exhaust gas through a purge valve 215 by means of the anode exhaust passage 214 connected to an intermediate part of the cathode exhaust passage 212. When anode-side hydrogen gas purging is performed, a discharged hydrogen gas is diluted by a cathode-side exhaust gas to less than the lower concentration limit of combustibility and is released into the outside air.

There is disclosed a technique to cool or heat an internal space within a casing of a fuel cell main unit including a multitude of cells stacked therein and the entire range of a fuel cell by using air inside a vehicle interior in an air-intake apparatus of a conventional air-cooled fuel cell. (Patent Literature 1 and Patent Literature 2)

### CITATION LIST

### Patent Literatures

### [PTL 1]

Japanese Patent Laid-Open No. 2006-076325

### [PTL 2]

Japanese Patent Laid-Open No. 2009-056940

### SUMMARY OF INVENTION

### Technical Problem

Incidentally, the operable temperature range of a fuel cell is fixed, and therefore, the fuel cell needs to be cooled and heated, so as to fall within the temperature range. Since an air-cooled fuel cell is particularly low in cooling capacity in general, compared with a water-cooled fuel cell, measures need to be taken in temperature regulation.

Hence, in Patent Literature 1 and Patent Literature 2, air inside a vehicle interior is used to cool or heat the internal space within the casing of the fuel cell main unit including the multitude of cells stacked therein and the entire range of the fuel cell. The techniques described in Patent Literature 1 and Patent Literature 2 are not designed to perform cooling or heating by utilizing an oxidizing gas supplied to the fuel cell main unit, however. Accordingly, the techniques cannot efficiently cool and heat the fuel cell main unit.

An object of this invention is to realize an air-intake apparatus for an air-cooled fuel cell capable of maintaining a fuel cell main unit at a temperature that enables power generation by providing temperature-regulated air to the air-cooled fuel cell as an oxidizing gas, and capable of efficiently cooling and heating the fuel cell main unit by utilizing the inside air of a vehicle.

### Solution to Problem

An air-intake apparatus for an air-cooled fuel cell according to this invention includes a fuel cell main unit to be mounted on a vehicle including an air-conditioning apparatus, supplies a temperature-regulated oxidizing gas to this fuel cell main unit, and cools the fuel cell main unit by utilizing one or more of this oxidizing gas and an ambient atmosphere, the air-intake apparatus comprising: outside air temperature-detecting means for detecting the temperature of outside air of a vehicle; an outside air flow passage for introducing the outside air of the vehicle; an outside air flow rate-regulating valve for regulating the flow rate of a gas flowing through this outside air flow passage; inside air temperature-detecting means for detecting the temperature of inside air of the vehicle; an inside air flow passage for introducing the inside air of the vehicle; an inside air flow rate-regulating valve for regulating the flow rate of a gas flowing through this inside air flow passage; an air-conditioning air passage for introducing the temperature-regulated air of the air-conditioning apparatus; an air-conditioning air flow rate-regulating valve for regulating the flow rate of a gas flowing through this air-conditioning air passage; and air-intake control means for driving and controlling the outside air flow rate-regulating valve, the inside air flow rate-regulating valve, and the air-conditioning air flow rate-regulating valve on the basis of respective temperatures detected by the outside air temperature-detecting means and the inside air temperature-detecting means, wherein this air-intake control means generates a gas temperature of which is optimized by making the gas pass through one or more of these flow passages and regulating valves, and supplies this gas to the fuel cell main unit as the oxidizing gas.

### Advantageous Effects of Invention

The air-intake apparatus for an air-cooled fuel cell according to this invention can maintain the fuel cell main unit at a temperature capable of causing power generation by providing temperature-regulated air to the air-cooled fuel cell as an oxidizing gas (also serving as cooling wind).

In addition, the air-intake apparatus for an air-cooled fuel cell according to this invention can efficiently cool and heat the fuel cell main unit by utilizing the inside air of a vehicle.

### BRIEF DESCRIPTION OF THE DRAWINGS

FIG. 1 is a flowchart of control by an air-intake apparatus for an air-cooled fuel cell. (Embodiment)

FIG. 2 is a block diagram of the air-intake apparatus for an air-cooled fuel cell. (Embodiment)

FIG. 3 is a drawing illustrating a gas flow in a case in which the temperature of outside air is included in a temperature range suited for an oxidizing gas. (Embodiment)

FIG. 4 is a drawing illustrating a gas flow in a case in which the temperature of inside air is included in the temperature range suited for the oxidizing gas. (Embodiment)

FIG. 5 is a drawing illustrating a gas flow in a case in which the temperature of inside air is closer to the temperature range suited for the oxidizing gas than the temperature of outside air. (Embodiment)

FIG. 6 is a drawing illustrating a gas flow in a case in which the temperature of outside air is closer to the temperature range suited for the oxidizing gas than the temperature of inside air. (Embodiment)

FIG. 7 is a block diagram of a water-cooled fuel cell. (Related art)

FIG. 8 is a block diagram of an air-cooled fuel cell. (Related art)

### DESCRIPTION OF EMBODIMENT

Hereinafter, an embodiment of this invention will be described according to the drawings.

### Embodiment

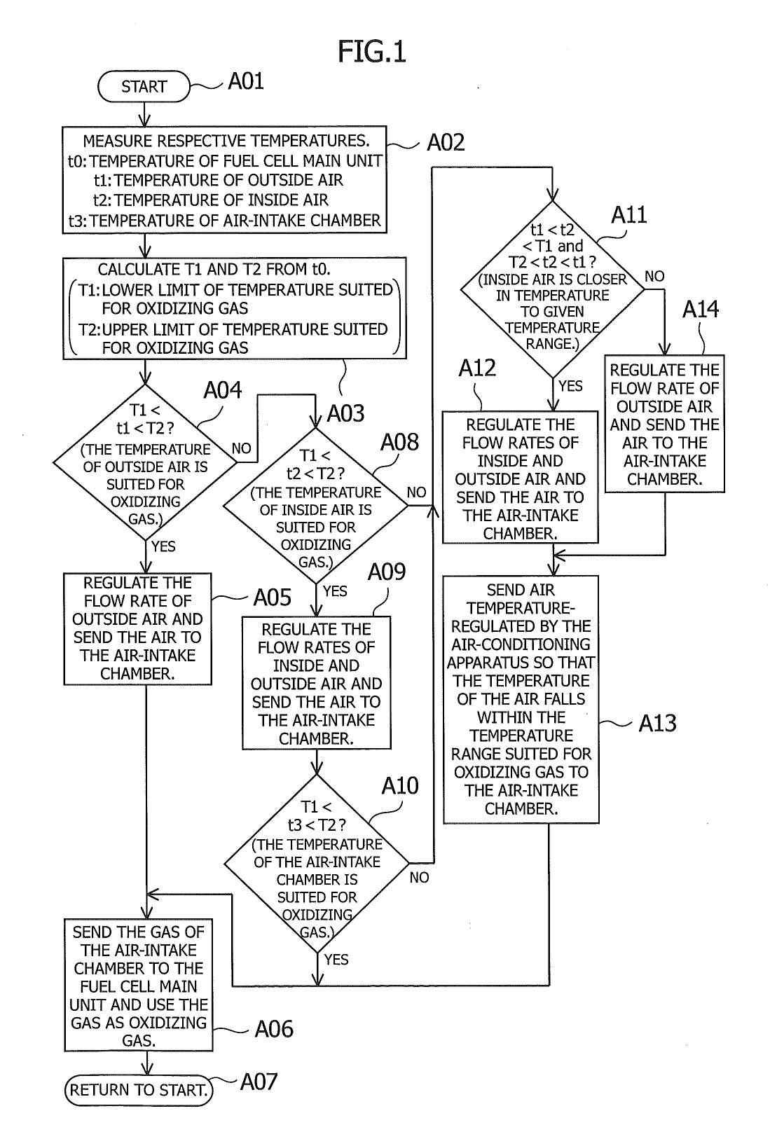

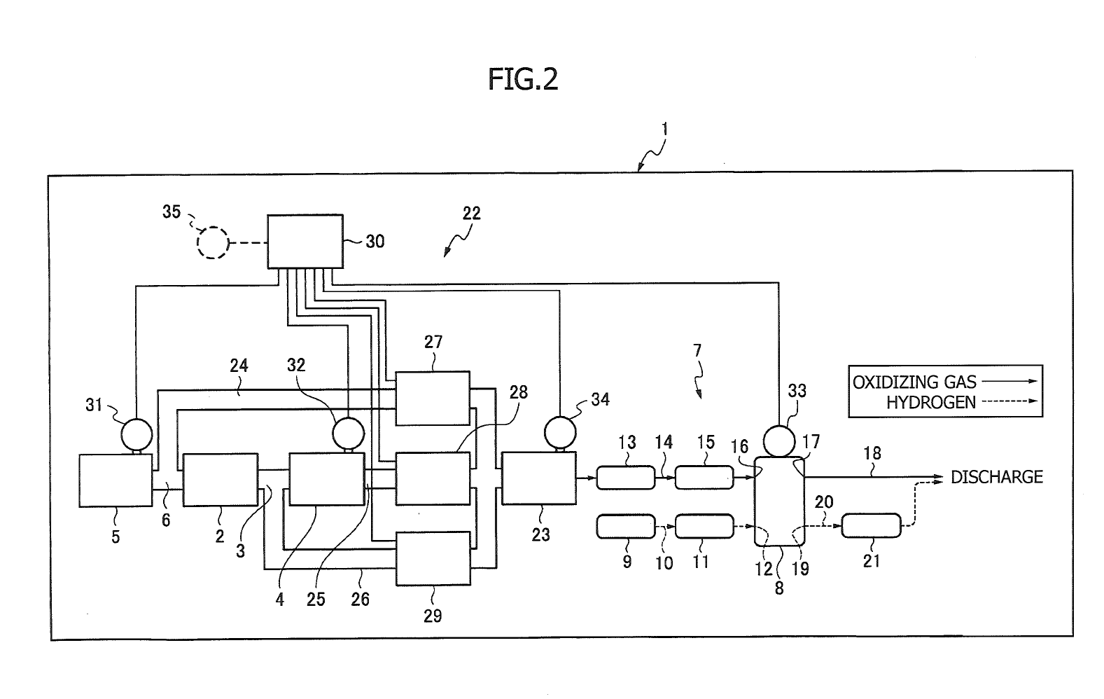

FIGS. 1 to 6 illustrate the embodiment of this invention. In FIG. 2, reference numeral 1 denotes a vehicle and reference numeral 2 denotes an air-conditioning apparatus. The air-conditioning apparatus 2 supplies air-conditioned air to a vehicle interior 4 by means of an air-conditioning passage 3. In addition, the air-conditioning apparatus 2 introduces outside air, as necessary, by means of an outside air-introducing passage 6 open to an outside 5. This vehicle 1 is mounted with an air-cooled fuel cell 7. The air-cooled fuel cell 7 is provided with a fuel cell main unit 8 including a multitude of cells of the minimum constituent unit (unit cells) stacked therein, and does not include any cooling structures, such as a coolant passage dedicated to cooling, within the fuel cell main unit 8.

The air-cooled fuel cell 7 depressurizes a compressed hydrogen gas stored in a high-pressure hydrogen tank 9 by a pressure-reducing valve 11 of an anode air-intake passage 10, and then introduces the gas to an anode air-intake unit 12 of the fuel cell main unit 8. On the other hand, the air-cooled fuel cell 7 uses intake-air taken into a cathode air-intake passage 14 through a filter 13 as an oxidizing gas, and supplies this oxidizing gas to a cathode air-intake unit 16 of the fuel cell main unit 8 by a gas supply fan 15. The oxidizing gas supplied to the cathode air-intake unit 16 not only is conducive to a power generation reaction in the multitude of cells stacked within the fuel cell main unit 8 as a gas for reaction with hydrogen, but also has the role of drawing waste heat from the fuel cell main unit 8 and cooling the fuel cell main unit 8.

The oxidizing gas, after having reacted with hydrogen and cooled down the fuel cell main unit 8, is discharged from a cathode exhaust unit 17 of the fuel cell main unit 8 into a cathode exhaust passage 18 and is released into the outside air. An anode exhaust gas discharged from an anode exhaust unit 19 of the fuel cell main unit 8 is introduced into an anode exhaust passage 20. The anode exhaust passage 20 is connected to the cathode exhaust passage 18, with a purge valve 21 located in a midway position therebetween. The anode exhaust gas of the anode exhaust passage 20 is mixed into the cathode exhaust gas of the cathode exhaust passage 18 through the purge valve 21. When anode-side hydrogen gas purging is performed, a discharged hydrogen gas is diluted by a cathode-side exhaust gas to less than the lower concentration limit of combustibility and is released into the outside air.

The air-cooled fuel cell 7 is provided with an air-intake apparatus 22 for supplying a temperature-regulated oxidizing gas to the fuel cell main unit 8 and cooling the fuel cell main unit 8 by utilizing one or more of this oxidizing gas and an ambient atmosphere (the inside air, outside air and air-conditioned air of the vehicle 1). The air-intake apparatus 22 is such that an air-intake chamber 23 is connected to the upstream side of the filter 13 of the cathode air-intake passage 14 for supplying the oxidizing gas to the air-cooled fuel cell 7. An outside air flow passage 24 for introducing the outside air (air of the outside 5) of the vehicle 1, an inside air flow passage 25 for introducing the inside air (air of the vehicle interior 4) of the vehicle 1, and an air-conditioning air passage 26 for introducing the temperature-conditioned air of the air-conditioning apparatus 2 are connected to the air-intake chamber 23.

The outside air flow passage 24 is such that the upstream side thereof is open to the outside 5 of the vehicle 1 through an outside air-introducing passage 6, and the downstream side thereof is connected to the air-intake chamber 23. The inside air flow passage 25 is such that the upstream side thereof is connected to the vehicle interior 4 into which the air-conditioned air of the air-conditioning apparatus 2 is supplied, and the downstream side thereof is connected to the air-intake chamber 23. The air-conditioning air passage 26 is such that the upstream side thereof is connected to the air-conditioning passage 3 of the air-conditioning apparatus 2, and the downstream side thereof is connected to the air-intake chamber 23.

An outside air flow rate-regulating valve 27 for regulating the flow rate of a gas flowing through this outside air flow passage 24 is provided in the outside air flow passage 24. An inside air flow rate-regulating valve 28 for regulating the flow rate of a gas flowing through this inside air flow passage 25 is provided in the inside air flow passage 25. An air-conditioning air flow rate-regulating valve 29 for regulating the flow rate of a gas flowing through this air-conditioning air passage 26 is provided in the air-conditioning air passage 26.

The outside air flow rate-regulating valve 27, the inside air flow rate-regulating valve 28 and the air-conditioning air flow rate-regulating valve 29 are connected to air-intake control means 30. Outside air temperature-detecting means 31 for detecting the temperature of outside air of the vehicle 1, inside air temperature-detecting means 32 for detecting the temperature of inside air of the vehicle 1, fuel cell temperature-detecting means 33 for detecting the temperature of the fuel cell main unit 8, and air-intake chamber temperature-detecting means 34 for detecting the temperature of an oxidizing gas within the air-intake chamber 23 formed by mixture of a freely selected combination of the inside air, the outside air and the air-conditioning air and supplied to the fuel cell main unit 8 are connected to the air-intake control means 30.

The air-intake control means 30 drives and controls the outside air flow rate-regulating valve 27, the inside air flow rate-regulating valve 28 and the air-conditioning air flow rate-regulating valve 29 by means of feedback control, on the basis of respective temperatures detected by the outside air temperature-detecting means 31 and the inside air temperature-detecting means 32, so that the temperatures fall within a temperature range (T1 to T2) of the fuel cell main unit 8 capable of causing power generation. The air-intake control means 30 generates a gas having a temperature optimized by making the gas pass through one or more of these flow passages 24 to 26 and regulating valves 27 to 29, and supplies this gas to the fuel cell main unit 8 as an oxidizing gas.

In addition, the air-intake control means 30 calculates the temperature range T1 to T2 suited for the oxidizing gas from the temperature of the fuel cell main unit 8 detected by the fuel cell temperature-detecting means 33. Then, the air-intake control means 30 temperature-regulates the oxidizing gas through one or more of the respective passages 24 to 26 and the respective regulating valves 27 to 29, so that the oxidizing gas settles to within this temperature range T1 to T2.

If a temperature t1 of outside air detected by the outside air temperature-detecting means 31 is included in the temperature range T1 to T2 (T1<t1<T2), the air-intake control means 30 regulates the outside air by the outside air flow rate-regulating valve 27 and supplies the outside air to the fuel cell main unit 8 as the oxidizing gas.

If a temperature t2 of inside air detected by the inside air temperature-detecting means 32 is included in the temperature range T1 to T2 (T1<t2<T2), the air-intake control means 30 regulates the inside air by the inside air flow rate-regulating valve 28 and the outside air by the outside air flow rate-regulating valve 27, and supplies a gas formed by mixing those gases to the fuel cell main unit 8 as the oxidizing gas.

Yet additionally, if a temperature t3 of the gas formed by mixture on the basis of the temperature t2 of the inside air detected by the inside air temperature-detecting means 32 and the temperature t1 of the outside air detected by the outside air temperature-detecting means 31 cannot be included in the temperature range T1 to T2 (t3≦T1, T2≦t3) and if the temperature t2 of the inside air detected by the inside air temperature-detecting means 32 is closer to the temperature range T1 to T2, the air-intake control means 30 regulates the temperature-conditioned air of the air-conditioning apparatus 2 by the air-conditioning air flow rate-regulating valve 29, the inside air by the inside air flow rate-regulating valve 28, and the outside air by the outside air flow rate-regulating valve 27, and supplies a gas formed by mixing those gases to the fuel cell main unit 8 as the oxidizing gas.

If the temperature t3 of the gas formed by mixture on the basis of the temperature t2 of the inside air detected by the inside air temperature-detecting means 32 and the temperature t1 of the outside air detected by the outside air temperature-detecting means 31 cannot be included in the temperature range T1 to T2 (t3≦T1, T2≧t3) and if the temperature t1 of the outside air detected by the outside air temperature-detecting means 31 is closer to the temperature range T1 to T2, the air-intake control means 30 regulates the temperature-conditioned air of the air-conditioning apparatus 2 by the air-conditioning air flow rate-regulating valve 29 and the outside air by the outside air flow rate-regulating valve 27, and supplies a gas formed by mixing those gases at the fuel cell main unit 8 as the oxidizing gas. Note that the temperature t3 of the mixed gas is a temperature detected by the air-intake chamber temperature-detecting means 34 provided in the air-intake chamber 23.

Next, operation will be described.

As, illustrated in FIG. 1, when control by the air-intake control means 30 starts (A01), the air-intake apparatus 22 of the air-cooled fuel cell 7 measures a temperature t0 of the fuel cell main unit 8, the temperature t1 of the outside air, the temperature t2 of the inside air, the temperature t3 of the oxidizing gas of the air-intake chamber 23 by the respective detecting means 31 to 34 (A02), and calculates the temperature range T1 to T2 suited for the oxidizing gas from the temperature t0 of the fuel cell main unit 8 (A03). Here, T1 denotes a lower limit of temperature suited for the oxidizing gas supplied to the fuel cell main unit 8, and T2 denotes an upper limit of temperature suited for the oxidizing gas supplied to the fuel cell main unit 8.

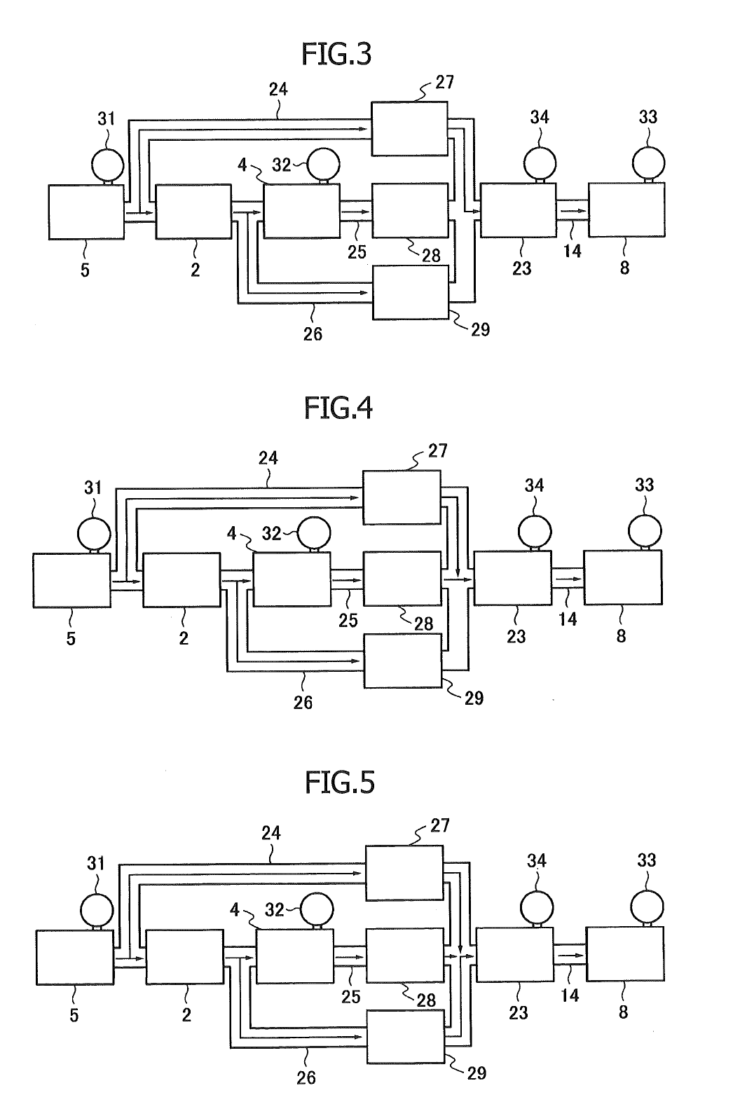

After calculating the temperature range T1 to T2 (A03), the air-intake apparatus 22 determines whether the temperature t1 of the outside air is included in the calculated temperature range T1 to T2 (A04). If this determination (A04) results in YES, the air-intake apparatus 22 regulates the outside air by the outside air flow rate-regulating valve 27 and sends the outside air to the air-intake chamber 23 (A05), supplies a gas formed of the outside air of the air-intake chamber 23 to the fuel cell main unit 8 as the oxidizing gas (A06), and returns to the START step (A01) (A07), as illustrated in FIG. 3.

If the determination (A04) results in NO, the air-intake apparatus 22 determines whether the temperature t2 of the inside air is included in the calculated temperature range T1 to T2 (A08). If this determination (A08) results in YES, the air-intake apparatus 22 regulates, by the inside air flow rate-regulating valve 28, the inside air air-conditioned by the air-conditioning apparatus 2 and supplied to the vehicle interior 4, regulates the outside air by the outside air flow rate-regulating valve 27, sends the outside air to the air-intake chamber 23 (A09), and determines whether the temperature t3 of the inside air and the outside air within the air-intake chamber 23 is included in the calculated temperature range T1 to T2 (A10), as illustrated in FIG. 4.

If this determination (A10) results in YES, the air-intake apparatus 22 supplies a gas formed by mixing the inside air and outside air of the air-intake chamber 23 to the fuel cell main unit 8 (A06) as the oxidizing gas, and returns to the START step (A01) (A07). The outside air when the temperature t2 of the inside air is included in the calculated temperature range T1 to T2 (A08: YES) is used to compensate for a shortfall in the flow rate of the inside air.

If the temperature of the gas falls outside the temperature range T1 to T2 due to the combined outside air (A08: NO, A10: NO), the air-intake apparatus 22 performs temperature regulation according to steps (Al 1 to A14) described below by using the temperature-regulated air-conditioning air of the air-conditioning apparatus 2.

If the determination (A08) results in NO and if the determination (A10) also results in NO, the air-intake apparatus 22 determines whether the temperature t2 of the inside air is closer to the temperature range T1 to T2 than the temperature t1 of the outside air (t1<t2<T1, T2<t2<t1) (A11). If this determination (A11) results in YES, the air-intake apparatus 22 regulates, by the inside air flow rate-regulating valve 28, the inside air air-conditioned by the air-conditioning apparatus 2 and supplied to the vehicle interior 4, and regulates the outside air by the outside air flow rate-regulating valve 27 to send the outside air to the air-intake chamber 23 (A12), as illustrated in FIG. 5.

The air-intake apparatus 22 regulates the temperature-conditioned air of the air-conditioning apparatus 2 by the air-conditioning air flow rate-regulating valve 29, so that the temperature t3 of the inside air and the outside air within the air-intake chamber 23 is included in the temperature range T1 to T2, and sends the air to the air-intake chamber 23 (A13). Then, the air-intake apparatus 22 supplies a gas formed by mixing the inside air and the outside air of the air-intake chamber 23 and air in the atmosphere to the fuel cell main unit 8 (A06) as the oxidizing gas, and returns to the START step (A01) (A07).

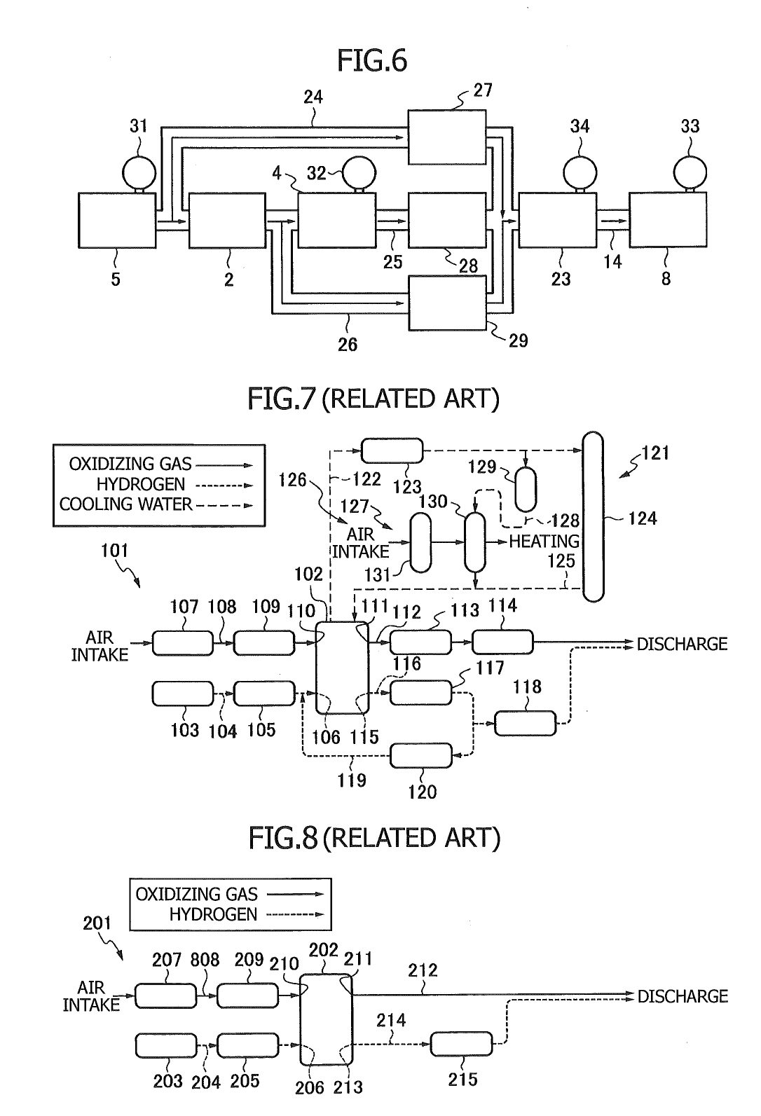

When the temperature t2 of the inside air is closer to the temperature range T1 to T2 than the temperature t1 of the outside air (A12: YES), the air of the outside air and the air of the air-conditioning apparatus 2 are used to compensate for a shortfall in the flow rate. If the determination (A11) results in NO, the temperature t1 of the outside air is closer to the temperature range T1 to T2 (t2<t1<T1, T2<t1<t2) than the temperature t2 of the inside air, and therefore, the air-intake apparatus 22 regulates the outside air by the outside air flow rate-regulating valve 27, sends the outside air to the air-intake chamber 23 (A14), regulates the temperature-conditioned air of the air-conditioning apparatus 2 by the air-conditioning air flow rate-regulating valve 29, so that the temperature t3 of the outside air within the air-intake chamber 23 is included in the temperature range T1 to T2, sends the air to the air-intake chamber 23 (A13), supplies a gas formed by mixing the inside air and outside air of the air-intake chamber 23 and the air of the air-conditioning apparatus 2 to the fuel cell main unit 8 as the oxidizing gas (A06), and returns to the START step (A01) (A07), as illustrated in FIG. 6. The air of the air-conditioning apparatus 2 when the temperature t1 of the outside air is closer to the temperature range T1 to T2 than the temperature t2 of the inside air (A12: NO) is used to compensate for a shortfall in the flow rate.

As described above, the air-intake apparatus 22 of the air-cooled fuel cell 7 drives and controls the respective regulating valves 27 to 29 on the basis of respective temperatures detected by the air-intake control means 30 by using the respective detecting means 31 to 34, so that the temperature t3 of the oxidizing gas supplied to the fuel cell main unit 8 falls within the predetermined temperature range (T1 to T2), thereby generating a gas optimized in temperature by making the gas to pass through the respective passages 24 to 26 and respective regulating valves 27 to 29, and supplies this gas to the fuel cell main unit 8 as the oxidizing gas.

Consequently, this air-intake apparatus 22 of the air-cooled fuel cell 7 can maintain the fuel cell main unit 8 at a temperature for efficient power generation by providing temperature-regulated intake-air to the air-cooled fuel cell 7 as the oxidizing gas (also serving as cooling wind). In addition, this air-intake apparatus 22 of the air-cooled fuel cell 7 can efficiently cool and heat the fuel cell main unit 8 by utilizing the inside air of the vehicle 1.

In addition, the air-intake apparatus 22 of the air-cooled fuel cell 7 calculates the temperature range T1 to T2 suited for the oxidizing gas from the temperature of the fuel cell main unit 8 detected by the fuel cell temperature-detecting means 33 by the air-intake control means 30, so that the oxidizing gas settles to within this temperature range T1 to T2, and temperature-regulates the gas through one or more of the respective passages 24 to 26 and respective regulating valves 27 to 29, thereby regulating the temperature t3 of the oxidizing gas supplied to the fuel cell main unit 8 on the basis of the temperature t0 of the fuel cell main unit 8. Thus, the air-intake apparatus 22 can maintain the fuel cell main unit 8 in a state of being able to generate electric power.

If the temperature t1 of the outside air detected by the outside air temperature-detecting means 31 is included in the temperature range T1 to T2 (T1<t1<T2), the air-intake apparatus 22 of the air-cooled fuel cell 7 regulates the outside air by the outside air flow rate-regulating valve 27 and supplies the outside air to the fuel cell main unit 8 by the air-intake control means 30 as the oxidizing gas. Consequently, the air-intake apparatus 22 of the air-cooled fuel cell 7 can secure a large volume of the oxidizing gas to serve as a medium for temperature regulation by using the outside air for the oxidizing gas and can, therefore, secure a long period of time for performing cooling and heating.

If the temperature t2 of the inside air detected by the inside air temperature-detecting means 32 is included in the temperature range T1 to T2 (T1<t2<T2), the air-intake apparatus 22 of the air-cooled fuel cell 7 regulates the inside air by the inside air flow rate-regulating valve 28 and the outside air by the outside air flow rate-regulating valve 27, and supplies a gas formed by mixing those gases at the fuel cell main unit 8 by the air-intake control means 30 as the oxidizing gas. The air-intake apparatus 22 of the air-cooled fuel cell 7, therefore, needs to secure a large volume of the oxidizing gas serving as a medium for temperature regulation, in order to secure a prolonged period of time for performing the cooling and heating of the fuel cell main unit 8. By combining the outside air with a limited volume of the inside air, the air-intake apparatus 22 secures a required volume of the oxidizing gas and can, therefore, secure a prolonged period of time for performing cooling and heating.

Yet additionally, if the temperature t3 of the gas formed by mixture on the basis of the temperature t2 of the inside air detected by the inside air temperature-detecting means 32 and the temperature t1 of the outside air detected by the outside air temperature-detecting means 31 cannot be included in the temperature range T1 to T2 (t3≦T1, T2≦t3) and if the temperature t2 of the inside air detected by the inside air temperature-detecting means 32 is closer to the temperature range T1 to T2, the air-intake apparatus 22 of the air-cooled fuel cell 7 regulates the temperature-conditioned air of the air-conditioning apparatus 2 by the air-conditioning air flow rate-regulating valve 29, the inside air by the inside air flow rate-regulating valve 28, and the outside air by the outside air flow rate-regulating valve 27, and supplies a gas formed by mixing those gases at the fuel cell main unit 4 by the air-intake control means 30 as the oxidizing gas.

Consequently, even though the temperature of the fuel cell main unit 8 may not immediately enter the optimum condition for the current intake-air, this air-intake apparatus 22 of the air-cooled fuel cell 7 can settle the temperature of the fuel cell main unit 8 to the optimum condition in a relatively short period of time. That is, this air-intake apparatus 22 of the air-cooled fuel cell 7 can shorten the time taken for the temperature of the fuel cell main unit 8 to enter the optimum condition, start operation under the optimum condition at an early point in time, and continue the operation for a prolonged period of time.

Still further, if the temperature t3 of the gas formed by mixture on the basis of the temperature t2 of the inside air detected by the inside air temperature-detecting means 32 and the temperature t1 of the outside air detected by the outside air temperature-detecting means 31 cannot be included in the temperature range T1 to T2 (t3≦T1, T2≦t3) and if the temperature t1 of the outside air detected by the outside air temperature-detecting means 31 is closer to the temperature range T1 to T2, the air-intake apparatus 22 of the air-cooled fuel cell 7 regulates the temperature-conditioned air of the air-conditioning apparatus 2 by the air-conditioning air flow rate-regulating valve 29 and the outside air by the outside air flow rate-regulating valve 27, and supplies a gas formed by mixing those gases to the fuel cell main unit 8 by the air-intake control means 30 as the oxidizing gas.

Consequently, even though the temperature of the fuel cell main unit 8 may not immediately enter the optimum condition for the current intake-air, this air-intake apparatus 22 of the air-cooled fuel cell 7 can settle the temperature of the fuel cell main unit 8 to the optimum condition in a relatively short period of time. That is, this air-intake apparatus 22 of the air-cooled fuel cell 7 can shorten the time taken for the temperature of the fuel cell main unit 8 to enter the optimum condition, start operation under the optimum condition at an early point in time, and continue the operation for a prolonged period of time.

Note that although in the above-described embodiment, the fuel cell is configured so that the exterior of the fuel cell main unit 8 is cooled by outside air, the fuel cell main unit 8 can alternatively be housed inside the vehicle interior 4. In addition, in the above-described embodiment, it is also possible to utilize a target blowout temperature calculated by target blowout temperature-calculating means 35 within the control unit of the air-conditioning apparatus 2 by inputting the target blowout temperature to the air-intake control means 28 by means of communication (CAN) with the control unit of the air-conditioning apparatus 2, as shown by undulating lines in FIG. 2. The air-cooled fuel cell 7 can further improve the accuracy of controlling oxidizing gas temperature by performing control of regulating the temperature t3 of the oxidizing gas of the air-intake chamber 23 to a desired temperature through the utilization of the target blowout temperature.

### INDUSTRIAL APPLICABILITY

This invention can maintain the fuel cell main unit of an air-cooled fuel cell at a temperature capable of causing power generation by supplying a temperature-regulated oxidizing gas to the fuel cell main unit, and can improve the efficiency of cooling and heating by using air inside a vehicle interior as the oxidizing gas of the fuel cell main unit also in a water-cooled fuel cell.

### REFERENCE SIGNS LIST

1 Vehicle

2 Air-conditioning apparatus

4 Vehicle interior

5 Outside

7 Air-cooled fuel cell

8 Fuel cell main unit

9 High-pressure hydrogen tank

11 Pressure-reducing valve

13 Filter

14 Cathode air-intake passage

15 Gas supply fan

18 Cathode exhaust passage

20 Anode exhaust passage

21 Purge valve

22 Air-intake apparatus

23 Air-intake chamber

24 Outside air flow passage

25 Inside air flow passage

26 Air-conditioning air passage

27 Outside air flow rate-regulating valve

28 Inside air flow rate-regulating valve

29 Air-conditioning air flow rate-regulating valve

30 Air-intake control means

31 Outside air temperature-detecting means

32 Inside air temperature-detecting means

33 Fuel cell temperature-detecting means

34 Air-intake chamber temperature-detecting means

35 Target blowout temperature-calculating means

1. An air-intake apparatus for an air-cooled fuel cell configured to include a fuel cell main unit to be mounted on a vehicle including an air-conditioning apparatus, supply a temperature-regulated oxidizing gas to this fuel cell main unit, and cool the fuel cell main unit by utilizing one or more of this oxidizing gas and an ambient atmosphere, the air-intake apparatus comprising:
outside air temperature-detecting means for detecting the temperature of outside air of a vehicle;
an outside air flow passage for introducing the outside air of the vehicle;
an outside air flow rate-regulating valve for regulating the flow rate of a gas flowing through this outside air flow passage;
inside air temperature-detecting means for detecting the temperature of inside air of the vehicle;
an inside air flow passage for introducing the inside air of the vehicle;
an inside air flow rate-regulating valve for regulating the flow rate of a gas flowing through this inside air flow passage;
an air-conditioning air passage for introducing the temperature-regulated air of the air-conditioning apparatus;
an air-conditioning air flow rate-regulating valve for regulating the flow rate of a gas flowing through this air-conditioning air passage; and
air-intake control means for driving and controlling the outside air flow rate-regulating valve, the inside air flow rate-regulating valve, and the air-conditioning air flow rate-regulating valve on the basis of respective temperatures detected by the outside air temperature-detecting means and the inside air temperature-detecting means,
wherein this air-intake control means generates a gas temperature of which is optimized by making the gas pass through one or more of these flow passages and regulating valves, and supplies this gas to the fuel cell main unit as the oxidizing gas.

2. The air-intake apparatus for an air-cooled fuel cell according to claim 1, wherein fuel cell temperature-detecting means for detecting the temperature of the fuel cell main unit is provided, and the air-intake control means calculates a temperature range suited for the oxidizing gas from the detected temperature of the fuel cell main unit and performs temperature regulation through one or more of the respective flow passages and the respective regulating valves, so that the temperature falls within this temperature range.

3. The air-intake apparatus for an air-cooled fuel cell according to claim 1, wherein if a temperature of outside air detected by the outside air temperature-detecting means is included in the temperature range, the air-intake control means regulates the outside air by the outside air flow rate-regulating valve and supplies the outside air to the fuel cell main unit as the oxidizing gas.

4. The air-intake apparatus for an air-cooled fuel cell according to claim 1, wherein if a temperature of inside air detected by the inside air temperature-detecting means is included in the temperature range, the air-intake control means regulates the inside air by the inside air flow rate-regulating valve and the outside air by the outside air flow rate-regulating valve, and supplies a gas formed by mixing those gases to the fuel cell main unit as the oxidizing gas.

5. The air-intake apparatus for an air-cooled fuel cell according to claim 1, wherein if a temperature of the gas formed by mixture on the basis of the temperature of the inside air detected by the inside air temperature-detecting means and the temperature of the outside air detected by the outside air temperature-detecting means cannot be included in the temperature range and if the temperature of the inside air detected by the inside air temperature-detecting means is closer to the temperature range, the air-intake control means regulates the temperature-conditioned air of the air-conditioning apparatus by the air-conditioning air flow rate-regulating valve, the inside air by the inside air flow rate-regulating valve, and the outside air by the outside air flow rate-regulating valve, and supplies a gas formed by mixing those gases to the fuel cell main unit as the oxidizing gas.

6. The air-intake apparatus for an air-cooled fuel cell according to claim 1, wherein if the temperature of the gas formed by mixture on the basis of the temperature of the inside air detected by the inside air temperature-detecting means and the temperature of the outside air detected by the outside air temperature-detecting means cannot be included in the temperature range and if the temperature of the outside air detected by the outside air temperature-detecting means is closer to the temperature range, the air-intake control means regulates the temperature-conditioned air of the air-conditioning apparatus by the air-conditioning air flow rate-regulating valve and the outside air by the outside air flow rate-regulating valve, and supplies a gas formed by mixing those gases to the fuel cell main unit as the oxidizing gas.

7. The air-intake apparatus for an air-cooled fuel cell according to claim 2, wherein if a temperature of outside air detected by the outside air temperature-detecting means is included in the temperature range, the air-intake control means regulates the outside air by the outside air flow rate-regulating valve and supplies the outside air to the fuel cell main unit as the oxidizing gas.

8. The air-intake apparatus for an air-cooled fuel cell according to claim 2, wherein if a temperature of inside air detected by the inside air temperature-detecting means is included in the temperature range, the air-intake control means regulates the inside air by the inside air flow rate-regulating valve and the outside air by the outside air flow rate-regulating valve, and supplies a gas formed by mixing those gases to the fuel cell main unit as the oxidizing gas.

9. The air-intake apparatus for an air-cooled fuel cell according to claim 2, wherein if a temperature of the gas formed by mixture on the basis of the temperature of the inside air detected by the inside air temperature-detecting means and the temperature of the outside air detected by the outside air temperature-detecting means cannot be included in the temperature range and if the temperature of the inside air detected by the inside air temperature-detecting means is closer to the temperature range, the air-intake control means regulates the temperature-conditioned air of the air-conditioning apparatus by the air-conditioning air flow rate-regulating valve, the inside air by the inside air flow rate-regulating valve, and the outside air by the outside air flow rate-regulating valve, and supplies a gas formed by mixing those gases to the fuel cell main unit as the oxidizing gas.

10. The air-intake apparatus for an air-cooled fuel cell according to claim 2, wherein if the temperature of the gas formed by mixture on the basis of the temperature of the inside air detected by the inside air temperature-detecting means and the temperature of the outside air detected by the outside air temperature-detecting means cannot be included in the temperature range and if the temperature of the outside air detected by the outside air temperature-detecting means is closer to the temperature range, the air-intake control means regulates the temperature-conditioned air of the air-conditioning apparatus by the air-conditioning air flow rate-regulating valve and the outside air by the outside air flow rate-regulating valve, and supplies a gas formed by mixing those gases to the fuel cell main unit as the oxidizing gas.
